(19) United States
(12) Patent Application Publication
(10) Pub. No.: US 2015/0120762 A1
(43) Pub. Date: Apr. 30, 2015

(54) COMPARISON-BASED ACTIVE SEARCHING/LEARNING

(71) Applicant: THOMSON LICENSING, Issy de Moulineaux (FR)

(72) Inventors: Efstratios Ioannidis, San Francisco, CA (US); Laurent Massoulie, Vaucresson (FR)

(21) Appl. No.: 14/399,871

(22) PCT Filed: May 9, 2013
(86) PCT No.: PCT/US2013/040248

§ 371 Date: Nov. 7, 2014

Related U.S. Application Data
(60) Provisional application No. 61/644,519, filed on May 9, 2012.

(51) Int. Cl. G06F 17/30; G06N 99/00

(52) U.S. Cl. CPC G06F 17/30451; G06N 99/005
USPC 707/752; 707/775

(57) ABSTRACT

A method is provided for performing a content search through comparisons, where a user is presented with two candidate objects and reveals which is closer to the user's intended target object. The disclosed principles provide active strategies for finding the user's target with few comparisons. The so-called rank-net strategy for noiseless user feedback is described. For target distributions with a bounded doubling constant, rank-net finds the target in a number of steps close to the entropy of the target distribution and hence of the optimum. The case of noisy user feedback is also considered. In that context a variant of rank-nets is also described, for which performance bounds within a slowly growing function (doubly logarithmic) of the optimum are found. Numerical evaluations on movie datasets show that rank-net matches the search efficiency of generalized binary search while incurring a smaller computational cost.

### CROSS-REFERENCE TO RELATED APPLICATIONS

This application claims the benefit of U.S. Provisional Application Ser. No. 61/644,519, filed May 9, 2012, which is incorporated by reference herein in its entirety.

### TECHNICAL FIELD

The present principles relate to comparison based active searching and learning.

### BACKGROUND OF THE INVENTION

Content search through comparisons is a method in which a user locates a target object in a large database in the following iterative fashion. At each step, the database presents to the user two objects, and the user selects among the pair the object closest to the target that she has in mind. In the next iteration, the database presents a new pair of objects based on the user's earlier selections. This process continues until, based on the user's answers, the database can uniquely identify the target she has in mind.

This kind of interactive navigation, also known as exploratory search, has numerous real-life applications. One example is navigating through a database of pictures of people photographed in an uncontrolled environment, such as Fickr or Picasa. Automated methods may fail to extract meaningful features from such photos. Moreover, in many practical cases, images that present similar low-level descriptors (such as SIFT (Scale-Invariant Feature Transform) features) may have very different semantic content and high level descriptions, and thus be perceived differently by users. On the other hand, a human searching for a particular person can easily select from a list of pictures the subject most similar to the person she has in mind.

Consider a database of objects represented by a set N and endowed with a distance metric d, that captures the “distance” or “dissimilarity” between different objects. Given a specific object t∈N, a “comparison oracle” is an oracle that can answer questions of the following kind:

“Between two objects x and y in N, which one is closest to t under the metric d?”

Formally, the behavior of a human user can be modeled by such a comparison oracle. In particular, assume that that the database of objects are pictures, represented by a set N endowed with a distance metric d.

The goal of interactive content search through comparisons is to find a sequence of proposed pairs of objects to present to the oracle/human leading to identifying the target object with as few queries as possible.

Content search through comparisons is a special case of nearest neighbor search (NNS), and can be seen as an extension of work that considers the NNS problem for objects embedded in a metric space. It is also assumed that the embedding has a small intrinsic dimension, an assumption that is supported in practice. In particular, a prior art approach introduces navigating nets, a deterministic data structure for supporting NNS in doubling metric spaces. A similar technique was considered for objects embedded in a space satisfying a certain sphere-packing property, while other work relied on growth restricted metrics; all of the above assumptions have connections to the doubling constant considered herein. In all of the above mentioned prior art approaches, the demand over the target objects is assumed to be homogeneous.

NNS with access to a comparison oracle was introduced in several prior works. A considerable advantage of these works is that the assumption that objects are a-priori embedded in a metric space is removed; rather than requiring that similarity between objects is captured by a distance metric, these prior works only assume that any two objects can be ranked in terms of their similarity to any target by the comparison oracle. Nevertheless, these works also assume homogeneous demand, and the present principles can be seen as an extension of searching with comparisons to heterogeneity. In this respect, another prior approach also assumes heterogeneous demand distribution. However, under the assumptions that a metric space exists and the search algorithm is aware of it, better results in terms of the average search cost are provided using the present principles. The main problem with the aforementioned approach is that the approach is memoryless, i.e., it does not make use of previous comparisons, whereas in the present solution, this problem is solved by deploying an E-net data structure.

### SUMMARY OF THE INVENTION

These and other drawbacks and disadvantages of the prior art are addressed by the present principles, which are directed to a method for comparison based active searching.

According to an aspect of the present principles, there are provided several methods and several apparatus for searching content within a data base. A first method is comprised of steps for searching for a target within a data base by first constructing a net of nodes having a size that encompasses at least a target, choosing a set of nodes within the net, and comparing a distance from a target to each node within the set of nodes. The method further comprises selecting a node, within the set of nodes, closest to the target in accordance with the comparing step and reducing the size of the net to a size still encompassing the target in response to the selecting step. The method also comprises repeating the choosing, comparing, selecting, and reducing steps until the size of the net is small enough to encompass only the target.

According to another aspect of the present principles, there is provided a first apparatus. The apparatus is comprised of means for constructing a net having a size that encompasses at least a target and means for choosing a set of nodes within the net. The apparatus also comprises comparator means that compares a distance from a target to each node within the set of nodes and a means for selecting that finds a node, within the set of nodes, closest to the target in accordance with the comparator means. The apparatus further comprises circuitry to reduce the size of the net to a size still encompassing the target in response to the selecting means, and control means for causing the choosing means, the comparator means, the selecting means, and the reducing means to repeat their operation until the size of the net is small enough to encompass only the target.

According to another aspect of the present principles, there is provided a second method. The method is comprised of the steps of constructing a net having a size that encompasses at least a target and of choosing at least one pair of nodes within the net. The method further comprises comparing, for a number of repetitions, a distance from a target to each node within each of the at least one pair of nodes, and selecting a node within each of the at least one pair that is closest to the target in accordance with the comparing step. The method further comprises reducing the size of the net to a size still encompassing the target in response to the selecting step, and repeating the choosing, comparing, selecting, and reducing steps until the size of the net is small enough to encompass only the target.

According to another aspect of the present principles, there is provided a second apparatus. The apparatus is comprised of means for constructing a net of nodes having a size that encompasses at least a target and means for choosing at least one pair of nodes within the net. The apparatus further comprises comparator means that compares, for a number of repetitions, a distance from a target to each node within the at least one pair of nodes, and a means for selecting a node, within the at least one pair of nodes, closest to the target in response to the comparator means. The apparatus further comprises means for reducing the size of the net to a size still encompassing the target in response to the selecting means and control means for causing the choosing means, the comparator means, the selecting means, and the reducing means to repeat their operations until the size of the net is small enough to encompass only the target.

These and other aspects, features and advantages of the present principles will become apparent from the following detailed description of exemplary embodiments, which are to be read in connection with the accompanying drawings.

### BRIEF DESCRIPTION OF THE DRAWINGS

FIG. 1 shows (a) a table of size, dimension, as well as the size of the Rank Net Tree hierarchy constructed for each sample dataset (b) expected query complexity and (c) expected computational complexity.

FIG. 2 shows (a) query and (b) computational complexity of the five algorithms as a function of the dataset size, and (c) query complexity as a function of n under a faulty oracle.

FIG. 3 shows example algorithms implemented by the present principles.

FIG. 4 shows a first embodiment of a method under the present principles.

FIG. 5 shows a first embodiment of an apparatus under the present principles.

FIG. 6 shows a second embodiment of a method under the present principles.

FIG. 7 shows a first embodiment of an apparatus under the present principles.

### DETAILED DESCRIPTION OF THE INVENTION

The present principles are directed to a method and apparatus for comparison based active searching. The method is termed “active searching” because there are repeated stages of comparisons using the results of a previous stage. The method navigates through a database of objects (e.g., objects, pictures, movies, articles, etc.) and presents pairs of objects to a comparison oracle which determines which of the two objects is the one closest to a target (e.g., a picture or movie or article, etc.) In the next iteration, the database presents a new pair of objects based on the user's earlier selections. This process continues until, based on the user's answers, the database can uniquely identify the target that the user has in mind. In each stage, a small list of objects is presented for comparison. One object among the list is selected as the object closest to the target; a new object list is then presented based on earlier selections. This process continues until the target is included in the list presented, at which point the target is found and the search terminates.

The approach described herein considers the problem under the scenario of heterogeneous demand, where the target object t∈N is sampled from a probability distribution μ. In this setting, interactive content search through comparisons has a strong relationship to the classic “twenty-questions game” problem. In particular, a membership oracle is an oracle that can answer queries of the following form:
“Given a subset A⊂N, does t belong to A?”

It is well known that to find a target t, one needs to submit at least H(μ) queries, on average, to a membership oracle, where H(μ) is the entropy of μ. Moreover, there exists an algorithm (Huffman coding) that finds the target with only H(μ)+1 queries on average.

Content search through comparisons departs from the above setup in assuming that the database N is endowed with the metric d. A membership oracle is stronger than a comparison oracle as, if the distance metric d is known, comparison queries can be simulated through membership queries. On the other hand, a membership oracle is harder to implement in practice: unless A can be expressed in a concise fashion, a user will answer a membership query in linear time in |A|. This is in contrast to a comparison oracle, for which answers can be given in constant time. In short, the problem addressed herein of search through comparisons seeks similar performance bounds to the classic setup (a) for an oracle that is easier to implement and (b) under an additional assumption on the structure of the database namely, that it is endowed with a distance metric.

Intuitively, the performance of searching for an object through comparisons will depend not only on the entropy of the target distribution, but also on the topology of the target set N, as described by the metric d. In particular, it has been established that Ω (cH(μ)) queries are necessary, in expectation, to locate a target using a comparison oracle, where c is the so-called doubling-constant of the metric d. Moreover, the inventors have previously provided a method that locates the target in O(c³ H log(1/μ*)) queries, in expectation, where μ*=minₓ∈_{N}μ(x). Under the present principles, an improvement on the previous bound is achieved using a method that locates the target with O(c⁵ H(μ)) queries, in expectation.

### Search Through Comparisons

Consider a large finite set of objects N of size n:=|N|, endowed with a distance metric d, capturing the “dissimilarity” between objects. A user selects a target t∈N from a prior distribution μ. The goal of the present principles will be to design an interactive method that queries the user with pairs of objects with the purpose of discovering t in as few queries as possible.

A comparison oracle is an oracle that, given two objects x,y and a target t, returns the closest object to t. More formally,

$$Oracle ( \text{?} ) = \{ \begin{matrix}\text{?} & if \text{?} ( \text{?} ) \text{?} \text{?} ( \text{?} ) \text{?} \\ \text{?} & if \text{?} ( \text{?} ) \text{?} \text{?} ( \text{?} ) \\ \text{?} & if \text{?} ( \text{?} ) \text{?} \text{?} ( \text{?} ) \text{?}\end{matrix} \\ \text{?} \text{indicates text missing or illegible when filed}$$

Though it is assumed that the metric d exists, a view of distances is constrained to only observing order relationships between objects. More precisely, there is only access to information that can be obtained through the comparison oracle. Given an object z, a comparison oracle O_{z} receives as a query an ordered pair (x, y)∈N² and answers the question “is z closer to x than to y?”, i.e.,

$${O}_{x} ( x , y ) = \{ \begin{matrix}+ 1 & if d ( x , z ) < d ( y , z ) \\ - 1 & if d ( x , z ) \geq d ( y , z )\end{matrix} \text{?} \\ \text{?} \text{indicates text missing or illegible when filed} \qquad ( 1 )$$

The method herein described for determining the unknown target t submits queries to a comparison oracle Oₜ—namely, the user. Assume, effectively, that the user can order objects with respect to their distance from t, but does not need to disclose (or even know) the exact values of these distances.

Next, assume that the oracle always gives correct answers; later, this assumption is relaxed by considering a faulty oracle that lies with probability ε<0.5.

The focus of the present principles is on determining which queries to submit to Oₜ that do not require knowledge of the distance metric d. The methods presented rely only on a priori knowledge of (a) the distribution μ and (b) the values of the mapping O_{z}: N²→{−l, +1}, for every z∈N. This is in line with the assumption that, although the distance metric d exists, it cannot be directly observed.

The prior μ can be estimated empirically as the frequency with which objects have been targets in the past. The order relationships can be computed off-line by submitting ⊖{n² log n) queries to a comparison oracle, and requiring ⊖{n²) space: for each possible target z∈N, objects in N can be sorted with respect to their distance from z with ⊖{n log n) queries to O_{z}.
The result of this sorting is stored in (a) a linked list, whose elements are sets of objects at equal distance from z, and (b) a hash-map, that associates every element y with its rank in the sorted list. Note that O_{z}{x, y) can thus be retrieved in O(1) time by comparing the relative ranks of x and y with respect to their distance from z.
The focus of the present principles is on adaptive algorithms, whose decision on which query in N² to submit next are determined by the oracle's previous answers. The performance of a method can be measured through two metrics. The first is the query complexity of the method, determined by the expected number of queries the method needs to submit to the oracle to determine the target. The second is the computational complexity of the method, determined by the time-complexity of determining the query to submit to the oracle at each step.

### A Lower Bound

Recall that the entropy of μ is defined as H(μ)=Σₓ∈_{supply(μ)}μ(x) log(1/μ(x)) where supp(μ) is the support of μ. Given an object x∈N, let Bₓ(r)={y∈N: d{x, y)≦r} the closed ball of radius r≧0 around x. Given a set A⊂N let μ(A)=Σₓ∈_{A}μ(x). The doubling constant c(μ) of a distribution μ to be the minimum c>0 for which μ(Bₓ(2R))≦cμ(Bₓ(R)), for any x∈supp(μ) and any R≧O.

The doubling constant has a natural connection to the underlying dimension of the dataset as determined by the distance d. Both the entropy and the doubling constant are also inherently connected to content search through comparisons. It has been shown that any adaptive mechanism for locating a target t must submit at least Ω(c(μ)H(μ)) queries to the oracle Oₜ, in expectation. Moreover, previous works have described an algorithm for determining the target in 0(c³ H(μ)Hₘₐₓ (μ)) queries, where Hₘₐₓ(μ)=maxₓ∈_{supp(μ)} log(1/μ(x)).

### Active Learning

Search through comparisons can be seen as a special case of active learning. In active learning, a hypothesis space H is a set of binary valued functions defined over a finite set Q, called the query space. Each hypothesis h∈H generates a label from {−l, +l} for every query q∈Q. A target hypothesis h* is sampled from H according to some prior μ; asking a query q amounts to revealing the value of h*(q), thereby restricting the possible candidate hypotheses. The goal is to uniquely determine h* in an adaptive fashion, by asking as few queries as possible.

For the present principles, the hypothesis space H is the set of objects N, and the query space Q is the set of ordered pairs N². The target hypothesis sampled from μ is none other than t. Each hypothesis/object z∈N is uniquely identified by the mapping O_{z}: N²→{−1, +l}, which is assumed to be a priori known.

A well-known algorithm for determining the true hypothesis in the general active-learning setting is the so-called generalized binary search (GBS) or splitting algorithm. Define the version space V⊂H to be the set of possible hypotheses that are consistent with the query answers observed so far, At each step, GBS selects the query q∈Q that minimizes |Σₕ∈ᵥμ(h)h(q)|. Put differently, GBS selects the query that separates the current version space into two sets of roughly equal (probability) mass; this leads, in expectation, to the largest reduction in the mass of the version space as possible, so GBS can be seen as a greedy query selection policy.

A bound on the query complexity of GBS is given by the following theorem:

Theorem 1. GBS makes at most OPT·(Hₘₐₓ(μ)+1) queries in expectation to identify hypothesis h*∈N, were OPT is the minimum expected number of queries made by any adaptive policy.

GBS in Search through Comparisons

For the present principles, the version space V comprises all possible objects in z∈N that are consistent with oracle answers given so far. In other words, Z∈V if O_{z}(x, y)=Oₜ (x, y) for all queries (x, y) submitted to the oracle so far. Selecting the next query therefore amounts to finding the pair (x, y) ∈N² that minimizes

f(x,y)=|Σ_{z∈v}μ(z)O_{z}(x,y)|. (2)

Simulations show that the query complexity of GBS is excellent in practice. This suggests that this upper bound could potentially be improved in the specific context of search through comparisons.

Nevertheless, the computational complexity of GBS is ⊖(n²|V|) operations per query, as it requires minimizing f(x,y) over all pairs in N². For large sets N, this can be truly prohibitive. This motivates us to propose a new algorithm, RANKNETSEARCH, whose computational complexity is 0(1) and its query complexity is within a 0(c⁵ (μ)) factor from the optimal.

### An Efficient Adaptive Algorithm

The method using the present principles is inspired by ε-nets, a structure introduced previously in the context of Nearest Neighbor Search (NNS). The main premise is to cover the version space (i.e., the currently valid hypotheses/possible targets) with a net, consisting of balls that have little overlap. By comparing the center of each ball with respect to their distance to the target, the method can identify the ball to which the target belongs. The search proceeds by restricting the version space to this ball and repeating the process, covering this ball with a finer net. The main challenge faced is that, contrary to standard NNS, there is no access to the underlying distance metric. In addition, the bounds on the number of comparisons made by ε-nets are worst case (i.e., prior-free); the construction using this method takes the prior μ into account to provide bounds in expectation.

### Rank Nets

To address the above issues, the present methods introduce the notion of rank nets, which will play the role of ε-nets in this setting. For some x∈N, consider the ball E=Bₓ(R)⊂N. For any y∈E, define

d_{y}(ρ,E)=inf{r:μ(B_{y}(r))≧ρμ(E)} (3)

to be the radius of the smallest ball around y that maintains a mass above p μ (E). Using this definition, define a p-rank net as follows.

Definition 1. For some p<1, a p rank net of E=Bₓ(R)⊂N is a maximal collection of points R c E such that for any two distinct y, y′∈R

d(y,y′)>min{d_{y}(ρ,E),d_{y′}(ρ,E)}. (4)

For any y∈R, consider the Voronoi cell

V_{y}={z∈E:d(y,x)≦d(y′,z),∀y′∈R,y′≠y}.

Also, define the radius r_{y} of the Voronoi cell V_{y} as r_{y}=inf{r:V_{y}⊂B_{y}(r)}.

Critically for purposes herein, a rank net and the Voronoi tesselation it defines can both be computed using only ordering information:

Lemma 1. A p-rank net R of E can be constructed in O(|E|(log |E|+|R|)) steps, and the balls B_{y}(r_{y})⊂E circumscribing the Voronoi cells around R can be constructed in O(|E∥R|) steps using only (a) μ and (b) the mappings O_{z}:N²→{−l, +1} for every z∈E.

With this result, the focus becomes how the selection of p affects the size of the net as well as the mass of the Voronoi balls around it. The next lemma bounds |R|.

Lemma 2. The size of the net R is at most c³/p.

The following lemma determines the mass of the Voronoi balls in the net.

Lemma 3. If r_{y}>0 then μ(B_{y}(r_{y}))≦c³pμ(E).

Note that Lemma 3 does not bound the mass of Voronoi balls of radius zero. The lemma in fact implies that, necessarily, high probability objects y (for which μ(y)>c³pμ(E)) are included in R and the corresponding balls B_{y}(r_{y}) are singletons.

### Rank Net Data Structure and Algorithm

Rank nets can be used to identify a target t using a comparison oracle Oₜ as described in Algorithm 1. Initially, a net R covering N is constructed; nodes y∈R are compared with respect to their distance from t, and the closest to the target is determined, say y*. Note that this requires submitting |R|−1 queries to the oracle. The version space V (the set of possible hypotheses) is thus the Voronoi cell V_{y}* and is a subset of the ball B_{y}*(r_{y}*). The method then proceeds by limiting the search to B_{y}*(r_{y}*) and repeating the above process. Note that, at all times, the version space is included in the current ball to be covered by a net. The process terminates when this ball becomes a singleton which, by construction, must contain the target.

One question in the above method is how to select p: by Lemma 3, small values lead to a sharp decrease in the mass of Voronoi balls from one level to the next, hence reaching the target with fewer iterations. On the other hand, by Lemma 2, small values also imply larger nets, leading to more queries to the oracle at each iteration. The method herein selects p in an iterative fashion, as indicated in the pseudocode of Algorithm 2. The method repeatedly halves p until all non-singleton Voronoi balls B_{y}* (r_{y}*) of the resulting net have a mass bounded by O.5μ(E). This selection leads to the following bounds on the corresponding query and computational complexity of RANKNETSEARCH:
Theorem 2. RANKNETSEARCH locates the target by making 4c⁶ (1+H(μ)) queries to a comparison oracle, in expectation. The cost of determining which query to submit next is O(n(log n+c⁶)log c).

In light of the lower bound on the query complexity of Ω(cH(μ)), the present method, RANKNETSEARCH, is within a 0(c⁵) factor of the optimal algorithm in terms of query complexity, and is thus order optimal for constant c. Moreover, the computational complexity per query is O(n(log n+c⁶), in contrast to the cubic cost of the GBS algorithm. This leads to drastic reductions in the computational complexity compared to GBS.

Note that the above computational cost can, in fact, be reduced to 0(1) through amortization. In particular, it is easy to see that the possible paths followed by RANKNETSEARCH define a hierarchy, whereby every object serves as a parent to the objects covering its Voronoi ball. This tree can be preconstructed, and a search can be implemented as a descent over this tree.

### Noisy Comparison Oracle

Now, consider noisy oracles, in which the answer to any given query O(x, y, t) is exact with probability 1−p_{x,y,t} and false otherwise, and this is independent for distinct queries. Assume in the sequel that the error probabilities p_{x,y,t} are bounded away from ½, i.e. there exists pₑ<½ such that p_{x,y,t}≦pₑ for all (x, y, t).

In this context, another embodiment of the present principles proposes a modification of the previous algorithm for which query complexity is bounded. The procedure still relies on a rank-net hierarchy constructed as before. However this embodiment uses repetitions at each round in order to bound the probability that the wrong element of a rank-net has been selected when moving one level down the hierarchy.

Specifically, for a given level l and rank-net size m, define a repetition factor R_{l,0,β}(l, m), where β>1 and l₀ are two design parameters, by

$$\text{?} ( 𝓁 , m ) := \frac{2 log ( {( 𝓁 + {𝓁}_{0} )}^{β} \text{?} {log}_{2} ( m ) \text{?} )}{{( 1 - \text{?} )}^{2}} . \\ \text{?} \text{indicates text missing or illegible when filed} \qquad ( 5 )$$

The modified algorithm then proceeds down the hierarchy, starting at the top level (l=0). The basic step, when at level l, with a set A of nodes in the corresponding rank-net, proceeds as follows. A tournament is organized among rank-net members, who are initially paired. Pairs of competing members are compared R_{l0,β}(l, |A|) times. The “player” from a given pair winning the largest number of games moves to the next stage, where it will be paired again with another winner of the first round, and so forth until only one player is left. Note that the number of repetitions R increases only logarithmically with the level l.

Bounds for the query complexity and the corresponding probability of accurate target identification will be derived by leveraging the following:
Lemma 4 Given a fixed target t and a noisy oracle with upper bound pₑ on the error probability, the tournament among elements of the set A with repetitions R_{l0,β}(l, |A|) returns the element in the set A that is closest to target t with probability at least 1−(l+l₀)^{-β}.

This can be proven by assuming for simplicity that there are no ties, i.e., there is a unique point in A that is closest to t. The case with ties can be deduced similarly. First, bound the probability p(R) that upon repeating R times queries O(x, y, t), among x and y the one that wins the majority of comparisons is not the closest to t. Because of the upper bound pₑ on the error probability, one has (ignoring the possibility of ties)

p(R)≦Pr(Bin(R,pₑ)≧R/2).

The Azuma-Hoeffding inequality ensures that the right hand side of the above inequality is no larger than exp(−R(½−pₑ)²/2). Upon replacing the number of repetitions R by the expression (5), one finds that the corresponding probability of error is upper-bounded by

$$p ( {R}_{{𝓁}_{0} , β} ( \text{?} \vert A \vert ) ) \leq {( 𝓁 + {𝓁}_{0} )}^{- β} \frac{1}{\text{?} {log}_{2} ( \vert A \vert ) \text{?}} . \\ \text{?} \text{indicates text missing or illegible when filed}$$

Consider now the games to be played by the element within A that is closest to t. There are at most [symbol] log₂(|A|) [symbol] such games. By the union bound, the probability that the closest element loses on any one of these games is no less than (l+l₀)^{-β}, as theorized.
Remark 1. To find the closest object to target t with the noiseless oracle, clearly O(|A|) number of queries are needed. The proposed algorithm achieves the same goal with high probability by making at most a factor 2 R_{l0,β}(l, |A|) more comparisons.

In this context, the algorithm just proposed verifies the following:

Theorem 3, The algorithm with repetitions and tournaments outputs the correct target with probability at least

$$1 - {\sum }_{𝓁 \geq {𝓁}_{0}}^{ } {𝓁}^{- β} in O ( \text{?} \text{?} log \frac{1}{\text{?}} log log \frac{1}{\text{?}} )$$

$$\text{?} \text{indicates text missing or illegible when filed}$$

queries.

Remark 2. Note that by choosing β>1 and sufficiently large lₒ the error probability can be made arbitrarily small. Note also, for uniform distribution pᵢ ≡1/n the extra factor log log(n) in addition to the term of order H(μ)=log(n).

This can be proven because by the union bound and the previous Lemma, conditionally on any target

$$t ∈ N that Pr ( success / T = t ) \geq 1 - \text{?} ( 1 - {𝓁}^{- β} ) . \\ \text{?} \text{indicates text missing or illegible when filed}$$

The number of comparisons given that the target is T=t is at most

$$\text{?} 2 \vert {N}_{𝓁} \vert {R}_{{𝓁}_{0} , β} ( {𝓁}_{0} \vert {N}_{𝓁} \vert ) = O ( log \frac{1}{\text{?}} log log \frac{1}{\text{?}} ) , \\ \text{?} \text{indicates text missing or illegible when filed}$$

where the O-term depends only on the doubling constant c, the error probability pₑ and the design parameters lₒ and β. The bound on the expected number of queries follows by averaging over t∈N.

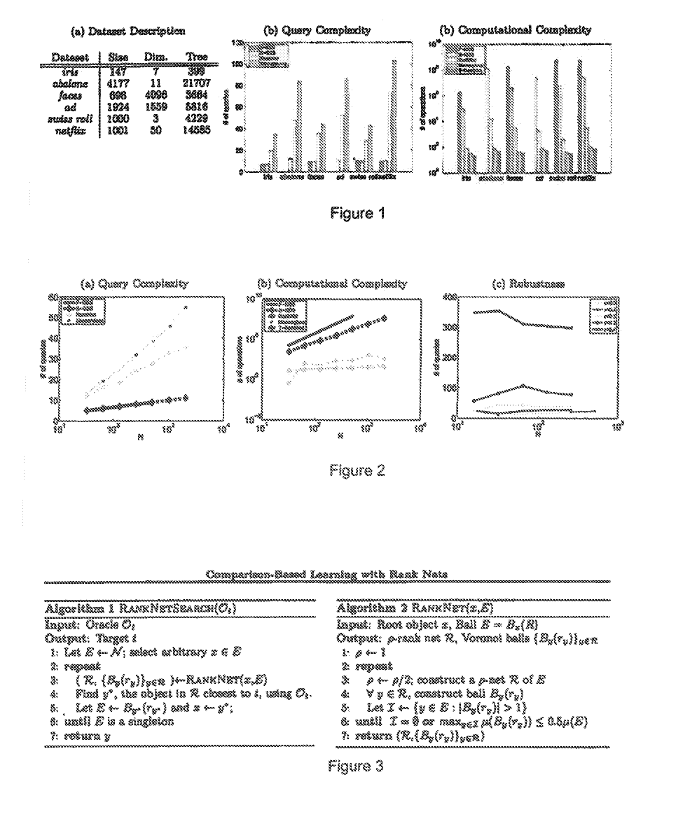

FIG. 1(a) shows a table of size, dimension (number of features), as well as the size of the Rank Net Tree hierarchy constructed for each dataset. FIG. 1(b) shows the expected query complexity, per search, of five algorithms applied on each data set. As RANKNET and T-RANKNET have the same query complexity, only one is shown. FIG. 1(c) shows the expected computational complexity, per search, of the five algorithms applied on each dataset. For MEMORYLESS and T-RANKNET this expected computational complexity equals the query complexity.

### Evaluation

The proposed method under the present principles, RANKNETSEARCH, can be evaluated over six publicly available datasets; iris, abalone, ad, faces, swiss roll (isomap), and netflix (netflix). The latter two can be subsampled, taking 1000 randomly selected data points from swiss roll, and the 1000 most rated movies in netflix.

These datasets are mapped to a Euclidian space R^{d} (categorical variables are mapped to binary values in the standard fashion); dimensions d is shown in the table of FIG. 1(a). For netflix, movies were mapped to 50-dimensional vectors by obtaining a low rank approximation of the user/movie rating matrix through SVD. Then, using l₂ as a distance metric between objects, select targets from a power-law prior with α=0.4.

The performance of two implementations of RankNetSearch:one was evaluated in which the rank net is determined online, as in Algorithm 1, and another one—denoted by T-RANKNETSEARcH—in which the entire hierarchy of rank nets is precomputed and stored as a tree. Both algorithms propose exactly the same queries to the oracle, so have the same query complexity; however, T-RANKNETSEARCH has only 0(1) computational complexity per query. The sizes of the trees precomputed by T-RANKNETSEARCH for each dataset are shown in the table of FIG. 1(a).

These algorithms are to be compared to (a) the memoryless policy proposed by one prior art method and (b) two heuristics based on GBS. The ⊖(n³) computational cost of GBS per query makes it intractable over the datasets considered here.

Like GBS, the first heuristic, termed F-GBS for fast GBS, selects the query that minimizes Equation (2). However, it does so by restricting the queries to pairs of objects in the current version space V. This reduces the computational cost per query to ⊖(|V|³), rather than ⊖(n²|V|). Of course, this is still ⊖(n³) for initial queries. The second heuristic, termed S-GBS for sparse CBS, exploits rank nets in the following way. First, the rank net hierarchy is constructed over the dataset, as in T-RANKNETSEACH. Then, in minimizing Equation (2), queries are restricted only to queries between pairs of objects that appear in the same net. Intuitively, S-GBS assumes that a “good” (i.e., equitable) partition of the objects can be found among such pairs.

Query vs. Computational Complexity

The query complexity of different algorithms, expressed as average number of queries per search, is shown in FIG. 1(b). Although there are no known guarantees for either F-GBS nor S-GBS, both algorithms are excellent in terms of query complexity across all datasets, finding the target within about 10 queries, in expectation. As CBS should perform as well as either of these algorithms, these suggest that it should also perform better as predicted by Theorem 1. The query complexity of RANKNETSEARCH is between 2 to 10 times higher query complexity; the impact is greater for high-dimensional datasets, as expected through the dependence of the rank net size on the c doubling constant. Finally, MEMORYLESS performs worse compared to all other algorithms.

As shown in FIG. 1, the above ordering is fully reversed with respect to computational complexity, measured as the aggregate number of operations performed per search. Differences from one algorithm to the next range between 50 to 100 orders of magnitude. F-GBS requires close to 10⁹ operations in expectation for some datasets; in contrast, RankNetSearch ranges between 100 and 1000 operations.

### Scalability and Robustness

To study how the above algorithms scale with the dataset size, the algorithms can be evaluated on a synthetic dataset comprising objects placed uniformly at random at R³, The query and computational complexity of the five algorithms is shown in FIGS. 2(a) and (b). FIG. 2 shows (a) query and (b) computational complexity of the five algorithms as a function of the dataset size. The dataset is selected uniformly at random from the l₁ ball of radius 1. FIG. 2(c) shows query complexity as a function of n under a faulty oracle.

The same discrepancies are present between algorithms that were noted in FIG. 1. The linear growth in terms of log n implies a linear relationship between both measures of complexity with respect to the entropy H(μ) for all methods. FIG. 2(b) shows a plot of the query complexity of the robust RANKNETSEARCH algorithm.

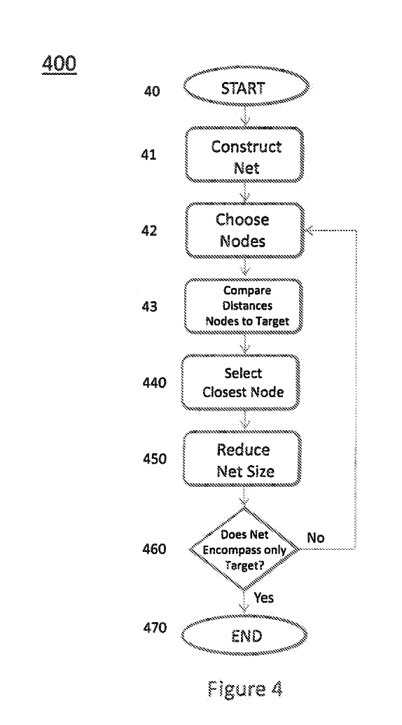

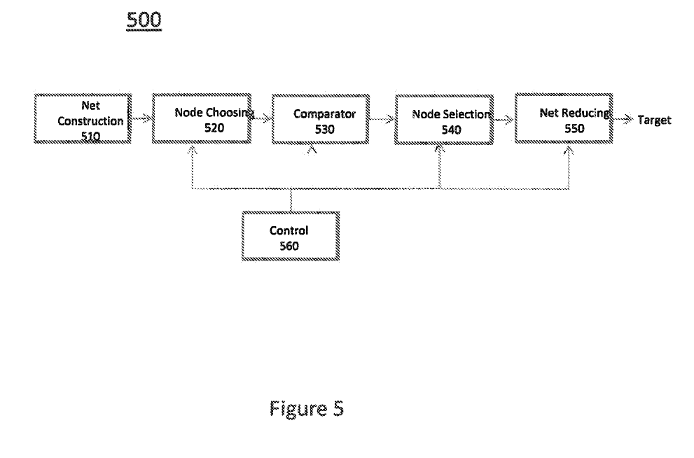

One embodiment of a first method 400 for searching for a target within a data base using the present principles is shown in FIG. 4. A start block 401 passes control to a function block 410. The function block 410 constructs a net of nodes having a size that encompasses a target. The function block 410 passes control to a function block 420, which chooses a set of nodes from within the net. Following block 420, control is passed to function block 430, which compares distances from a target to each node within the set of nodes. Control is passed from function block 430 to function block 440, which performs selection of a node closest to the target in accordance with the comparing of function block 430. Control is passed from function block 440 to function block 450, which reduces the net to a size still encompassing the target in accordance with selecting occurring during function block 440. Control is passed from function block 450 to control block 460, which causes a repeat of function blocks 420, 430, 440, and 450 until the size of the net is small enough to encompass only the target. When the net only encompasses the target, the method stops.

One embodiment of a first apparatus for searching for a target within a data base using the present principles is shown in FIG. 5 and is indicated generally by the reference numeral 500. The apparatus may be implemented as standalone hardware, or be executed by a computer. The apparatus comprises means 510 for constructing a net of nodes having a size that encompasses at least a target. The output of means 510 is in signal communication with the input of means 520 for choosing a set of nodes within the net. The output of choosing means 520 is in signal communication with the input of comparator means 530 that compares distances from a target to each node within the set of nodes. The output of comparator means 530 is in signal communication with the input of selecting means 540, which selects the node, within the set of nodes, closest to the target in response to comparator means 530. The output of selecting means 540 is in signal communication with means 550 for reducing the net to a size still encompassing the target in response to selecting means 540. The output of reducing means 550 is in signal communication with control means 560. Control means 560 will cause choosing means 520, comparator means 530, selecting means 540, and reducing means 550 to repeat their operations until the size of the net is small enough to encompass only the target.

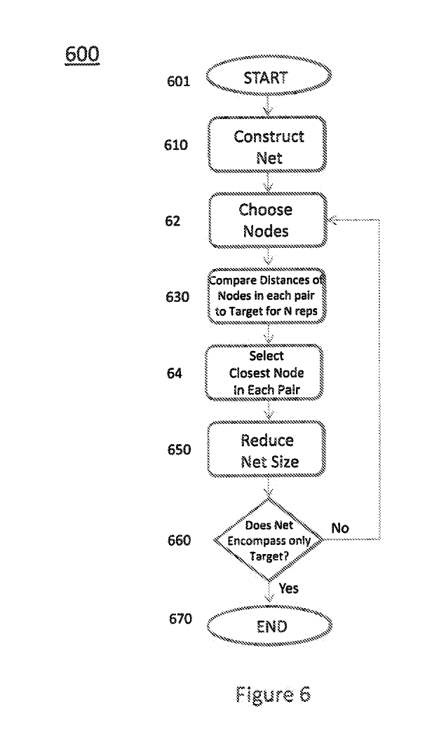

An embodiment of a second method 600 for searching for a target within a data base using the present principles is shown in FIG. 6. A start block 601 passes control to a function block 610. The function block 610 constructs a net of nodes having a size that encompasses a target. The function block 610 passes control to a function block 620, which chooses at least one pair of nodes from within the net. Following block 620, control is passed to function block 630, which compares distances from a target to each node within each of the at least one pair nodes, for a number of repetitions. Control is passed from function block 630 to function block 640, which performs selection of a node, within each of the at least one pair of nodes, that is closest to the target in accordance with the comparing of function block 630, over the course of the number of repetitions. Control is passed from function block 640 to function block 650, which reduces the net to a size still encompassing the target in accordance with selecting occurring during function block 640. Control is passed from function block 650 to control block 660, which causes a repeat of function blocks 620, 630, 640, and 650 until the size of the net is small enough to encompass only the target. When the net only encompasses the target, the method stops.

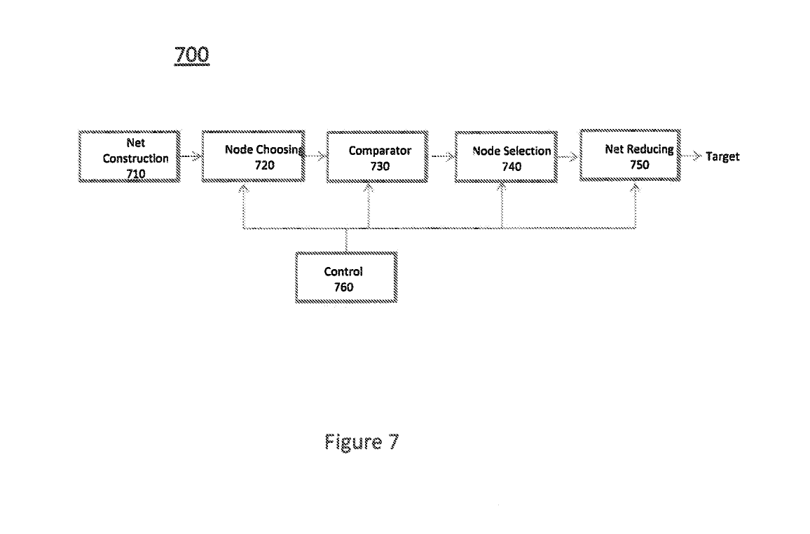

An embodiment of a second apparatus for searching for a target within a data base using the present principles is shown in FIG. 7 and is indicated generally by the reference numeral 700. The apparatus may be implemented as standalone hardware, or be executed by a computer. The apparatus comprises means 710 for constructing a net of nodes having a size that encompasses at least a target. The output of means 710 is in signal communication with the input of means 720 for choosing at least one pair of nodes within the net. The output of choosing means 720 is in signal communication with the input of comparator means 730 that compares distances from a target to each node within the at least one pair of nodes, over a number of repetitions. The output of comparator means 730 is in signal communication with the input of selecting means 740, which selects the node, within the at least one pair of nodes, closest to the target in response to comparator means 730. The output of selecting means 740 is in signal communication with means 750 for reducing the net to a size still encompassing the target in response to selecting means 540. The output of reducing means 750 is in signal communication with control means 760. Control means 760 will cause choosing means 720, comparator means 730, selecting means 740, and reducing means 750 to repeat their operations until the size of the net is small enough to encompass only the target.

One or more implementations having particular features and aspects of the presently preferred embodiments of the invention have been provided. However, features and aspects of described implementations can also be adapted for other implementations. For example, these implementations and features can be used in the context of other video devices or systems. The implementations and features need not be used in a standard.

Reference in the specification to “one embodiment” or “an embodiment” or “one implementation” or “an implementation” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment” or “in one implementation” or “in an implementation”, as well any other variations, appearing in various places throughout the specification are not necessarily all referring to the same embodiment.

The implementations described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or computer software program). An apparatus can be implemented in, for example, appropriate hardware, software, and firmware. The methods can be implemented in, for example, an apparatus such as, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Implementations of the various processes and features described herein can be embodied in a variety of different equipment or applications. Examples of such equipment include a web server, a laptop, a personal computer, a cell phone, a PDA, and other communication devices. As should be clear, the equipment can be mobile and even installed in a mobile vehicle.

Additionally, the methods can be implemented by instructions being performed by a processor, and such instructions (and/or data values produced by an implementation) can be stored on a processor-readable medium such as, for example, an integrated circuit, a software carrier or other storage device such as, for example, a hard disk, a compact disc, a random access memory (“RAM”), or a read-only memory (“ROM”). The instructions can form an application program tangibly embodied on a processor-readable medium. Instructions can be, for example, in hardware, firmware, software, or a combination. Instructions can be found in, for example, an operating system, a separate application, or a combination of the two. A processor can be characterized, therefore, as, for example, both a device configured to carry out a process and a device that includes a processor-readable medium (such as a storage device) having instructions for carrying out a process. Further, a processor-readable medium can store, in addition to or in lieu of instructions, data values produced by an implementation.

As will be evident to one of skill in the art, implementations can use all or part of the approaches described herein. The implementations can include, for example, instructions for performing a method, or data produced by one of the described embodiments.

A number of implementations have been described. Nevertheless, it will be understood that various modifications can be made. For example, elements of different implementations can be combined, supplemented, modified, or removed to produce other implementations. Additionally, one of ordinary skill will understand that other structures and processes can be substituted for those disclosed and the resulting implementations will perform at least substantially the same function(s), in at least substantially the same way(s), to achieve at least substantially the same result(s) as the implementations disclosed. Accordingly, these and other implementations are contemplated by this disclosure and are within the scope of these principles.

1. A method for searching for a target within a data base, comprising:
constructing a net of nodes having a size that encompasses at least a target;
choosing a set of nodes within the net;
comparing a distance from a target to each node within the set of nodes;
selecting a node, within the set of nodes, closest to the target in accordance with said comparing step;
reducing the net to a size still encompassing the target in accordance with said selecting step;
repeating said choosing, comparing, selecting, and reducing steps until the size of the net is small enough to encompass only the target.

2. The method of claim 1, wherein said reducing step reduces the net so that the net is centered on said node closest to the target and the net has a radius no larger than the distance of said closest node to the target.

3. The method of claim 2, wherein the net is defined by a Voronoi cell.

4. The method of claim 3, the Voronoi cell has tessellations computed using ordering information regarding distances of nodes.

5. The method of claim 1, wherein the comparison of distances uses Euchlidean distance.

6. The method of claim 1, wherein said repeating step is performed for at least two iterations.

7. A computer for searching content within a data base, comprising:
means for constructing a net of nodes having a size that encompasses at least a target;
means for choosing a set of nodes within the net;
comparator means that compares a distance from a target to each node within the set of nodes;
means for selecting a node, within the set of nodes, closest to the target in response to said comparator means;
means for reducing the net to a size still encompassing the target in response to said selecting means;
and
control means for causing, said means for choosing, said comparator means, said selecting means, and said means for reducing to repeat their operations until the size of the net is small enough to encompass only the target.

8. The apparatus of claim 7, wherein said means for reducing the size of the net reduces the net so as to be centered on said node closest to the target and the net has a radius no larger than the distance of said closest node to the target.

9. The apparatus of claim 8, wherein the net is defined by a Voronoi cell.

10. The apparatus of claim 9, the Voronoi cell has tessellations computed using only ordering information regarding distances of nodes.

11. The apparatus of claim 7, wherein the comparator means uses Euchlidean distance.

12. The apparatus of claim 7, wherein said control circuitry causes a repeat of operations to be performed for at least two iterations.

13. A method for searching for a target within a data base, comprising:
constructing a net of nodes having a size that encompasses at least a target;
choosing at least one pair of nodes within the net;
comparing, for a number of repetitions, a distance from a target to each node within each of the at least one pair of nodes;
selecting a node, within each of the at least one pairs, that is closest to the target in accordance with said comparing step;
reducing the net to a size still encompassing the target in response to said selecting step;
repeating said choosing, comparing, selecting, and reducing steps until the size of the net is small enough to encompass only the target.

14. The method of claim 13, wherein said reducing step reduces the net so that the net is centered on said node closest to the target and the net has radius no larger than the distance of said closest node to the target.

15. The method of claim 14, wherein the net is defined by a Voronoi cell.

16. The method of claim 15, the Voronoi cell has tessellations computed using ordering information regarding distances of nodes.

17. The method of claim 13, wherein the comparison of distances uses Euchlidean distance.

18. The method of claim 13, wherein said repeating step is performed for at least two iterations.

19. A computer for searching content within a data base, comprising:
means for constructing a net of nodes having a size that encompasses at least a target;
means for choosing at least one pair of nodes within the net;
comparator means that compares, for a number of repetitions, a distance from a target to each node within the at least one pair of nodes;
means for selecting a node, within the at least one pair of nodes, closest to the target in response to said comparator means;
means for reducing the size of the net to a size still encompassing the target in response to said selecting means;
and
control means for causing said choosing means, said comparator means, said selecting means, and said reducing means to repeat their operations until the size of the net is small enough to encompass only the target.

20. The apparatus of claim 7, wherein said means for reducing the net reduces the net so as to be centered on said node closest to the target and the net has radius no larger than the distance of said closest node to the target.

21. The apparatus of claim 8, wherein the net is defined by a Voronoi cell.

22. The apparatus of claim 9, the Voronoi cell has tessellations computed using only ordering information regarding distances of nodes.

23. The apparatus of claim 7, wherein the comparator means uses Euchlidean distance.

24. The apparatus of claim 7, wherein said control means causes a repeat of operations to be performed for at least two iterations.
